(19) United States
(12) Patent Application Publication
(10) Pub. No.: US 2005/0259515 A1
(43) Pub. Date: Nov. 24, 2005

(54) Fish detector

(76) Inventor: Tamotsu Maesawa, Chiba-shi (JP)

Correspondence Address: BRUCE L. ADAMS, ESQ., 31ST FLOOR, 50 BROADWAY, NEW YORK, NY, 10004, US

(21) Appl. No.: 11/121,252

(22) Filed: May 3, 2005

(30) Foreign Application Priority Data
May 19, 2004 (JP) 2004-148936

(51) Int. Cl. G01S 15/96

(52) U.S. Cl. 367/111

(57) ABSTRACT

To make it possible that a user of a fish detector for a fishing from rocks near the shore, which possesses an arm-portable type data display unit, can simply and surely know an approach of a fish shoal. An arm-portable type data display unit possesses a function of judging the approach of the fish shoal by receiving a radio signal from an ultrasonic sensor unit and generating a fish shoal approach signal. The arm-portable type data display unit possesses a vibration type notification section comprising a motor driving circuit and a vibration motor. The arm-portable type data display unit drives the vibration type notification section on the basis of the fish shoal approach signal to give a vibration to the user, thereby notifying the approach of the fish shoal.

### BACKGROUND OF THE INVENTION

1. Field of the Invention

The present invention relates to a fish detector for a fishing from rocks near the shore, which comprises an ultrasonic sensor unit possessing in combination also a function of a float of a fishing tackle, and a data display unit receiving a radio signal from the ultrasonic sensor unit to thereby display a fish shoal and the like.

2. Description of the Prior Art

In Japanese Patent No. 3490589 Gazette (Patent Document 1), JP-A-2002-272338 Gazette (Patent Document 2), JP-A-2002-286841 Gazette (Patent Document 3) and the like, there is disclosed a fish detector comprising a sensor unit which, while having the function of the float of the fishing tackle, sends out an ultrasonic wave toward a water bottom and transmits by radio a time information till the ultrasonic wave is reflected by the water bottom or the fish shoal and returns to it, and a data display unit which receives a radio signal from the sensor unit and displays from a received data a water depth or the fish shoal to a liquid crystal panel.

The data display unit used in the fish detector of each of these Patent Documents 1-3 is a fishing-rod-mounted type data display unit. However, since the fishing-rod-mounted type data display unit is always mounted near to a gripping portion of the fishing rod, there is a problem that the display is difficult to see for a user. Whereupon, as shown in FIG. 1, there has appeared a fish detector for the fishing from rocks near the shore, which possesses an arm-portable type data display unit 20 mounted to a wrist of the user. That is, this fish detector for the fishing from rocks near the shore is constituted by the arm-portable type data display unit 20 mounted to an arm of a user 1 who is enjoying the fishing from rocks near the shore, and an ultrasonic sensor unit 10 serving also as a float, which has been attached to a fishline 3 hanging from a tip of a fishing rod 2. The ultrasonic sensor unit 10 radiates the ultrasonic wave toward the water bottom, and obtains the time information till the ultrasonic wave is reflected by the water bottom or the fish shoal and returns to it. And, the ultrasonic sensor unit 10 radio-transmits the time information toward the arm-portable type data display unit 20 from a transmitting antenna 10a. The arm-portable type data display unit 20 receives the time information from the ultrasonic sensor unit 10, judges the water depth and the fish shoal, and image-displays these to a liquid crystal display panel.

Although a contrivance is elaborated in each of them in its portable property and operability, with such a data display unit, it is not easy for the user to know an approach of the fish shoal. This is because, although a considerable concentrated power is required in order to carefully see the liquid crystal panel and judge the approach of the fish shoal from a display image, for the user who is holding the fishing rod intact it is practically, considerably difficult to perform such operation and judgment.

Whereupon, in the Patent Document 3, there is disclosed a data display unit possessing a function of judging the approach of the fish shoal to thereby generate a fish shoal approach signal, and additionally a sound notifying function of notifying the approach of the fish shoal by buzzer sound on the basis of the fish shoal approach signal. However, if the sound notifying function is possessed in the data display unit mounted to the fishing rod, there is a problem that, depending on a fish that is made the target of the fishing or a fishing place, it is difficult to generate a large sound. This is because the large buzzer sound gives an undesirable vibration to the fishing rod. Reversely, with a small sound, there is a case where it cannot be heard by the user due to sounds of wind and wave. Accordingly, it cannot necessarily be said that one possessing the sound notifying function of notifying the approach of the fish shoal by the buzzer sound in the data display unit of the fish detector for the fishing from rocks near the shore is sufficient.

<Patent Document 1> Japanese Patent No. 3490589 Gazette

<Patent Document 2> JP-A-2002-272338 Gazette

<Patent Document 3> JP-A-2002-286841 Gazette

A problem that the present invention is to solve is to make it possible that the user of the fish detector for the fishing from rocks near the shore, which possesses the arm-portable type data display unit, can simply and surely know the approach of the fish shoal.

### SUMMARY OF THE INVENTION

In order to solve the above problem, it has been adapted such that, in the fish detector for the fishing from rocks near the shore which possesses the arm-portable type data display unit, a vibration is given to a body of the user by a vibration type notification unit which has been possessed in the arm-portable type data display unit, thereby notifying the approach of the fish shoal.

A fish detector concerning the present invention has an ultrasonic sensor unit which is accommodated in a container, serving also as a float, used while being attached to a fishline and which transmits by radio a time information till an ultrasonic wave having been sent out toward a water bottom is reflected by the water bottom or a fish shoal and returns to it, a control section which judges a water depth and the fish shoal on the basis of a data received from the ultrasonic sensor unit, a vibration type notification section which notifies an approach of the fish shoal to a user by vibration, and a display section which displays an information to a display screen.

And, it may be adapted such that the vibration type notification section gives the vibration to an arm of the user, or vibrates by a pattern corresponding to a size of signs of fish. Further, it may be adapted such that the vibration type notification section generates the vibration by a vibration motor.

Further, the fish detector of the present invention can be also combined with a sound notifying unit which notifies the approach of the fish shoal to the user by a sound notification. It may be adapted such that the control section selects either or both of the vibration type notification section and the sound notifying unit.

### BRIEF DESCRIPTION OF THE SEVERAL VIEWS OF THE DRAWINGS

A preferred form of the present invention is illustrated in the accompanying drawings in which:

FIG. 1 is a diagram showing a use situation of a fish detector for a fishing from rocks near the shore, which possesses an arm-portable type data display unit;

FIG. 2 is a block circuit diagram of an ultrasonic sensor unit constituting the fish detector of an Embodiment 1 of the present invention;

FIG. 3 is a block circuit diagram of the arm-portable type data display unit constituting the fish detector of the Embodiment 1 of the present invention;

FIG. 4 is a schematic plan view of the arm-portable type data display unit constituting the fish detector of the Embodiment 1 of the present invention; and

FIG. 5 is one example of waveform diagrams of drive patterns of a vibration motor possessed in the arm-portable type data display unit constituting the fish detector of the Embodiment 1 of the present invention.

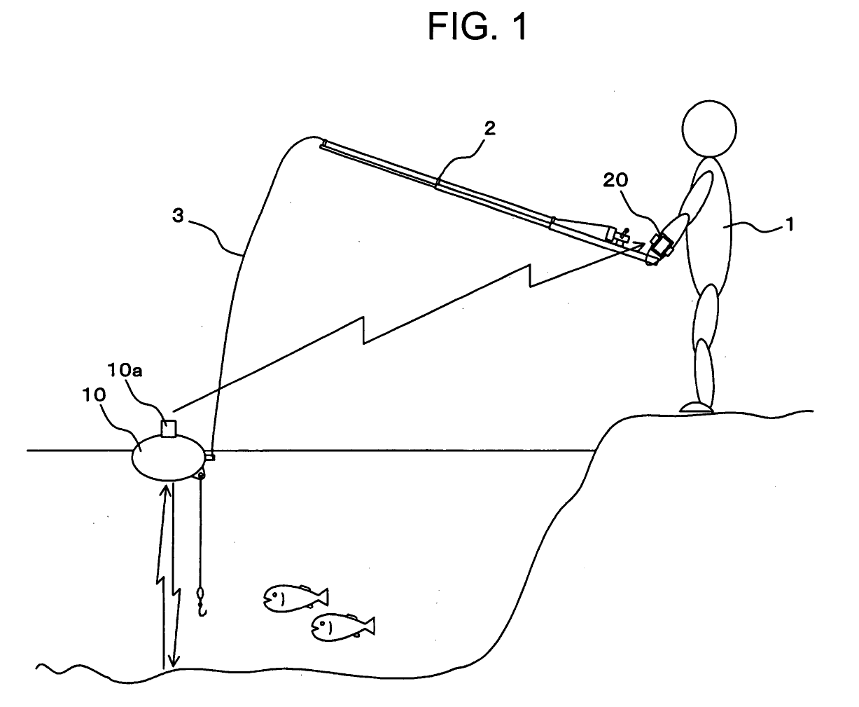

### DETAILED DESCRIPTION OF THE PREFERRED EMBODIMENTS

In the present invention, in a fish detector constituted by an ultrasonic sensor unit which is accommodated in a container, serving also as a float, used while being attached to a fishline and which transmits by radio a time information till an ultrasonic wave having been sent out toward a water bottom is reflected by the water bottom or a fish shoal and returns to it, and a portable type data display unit possessing a control section which judges a water depth and the fish shoal on the basis of a data received from the ultrasonic sensor unit and a display section which displays a water depth and the like to a display screen, a vibration type notification section which notifies the approach of the fish shoal to the user by vibration has been additionally possessed in the portable type data display unit.

### Embodiment 1

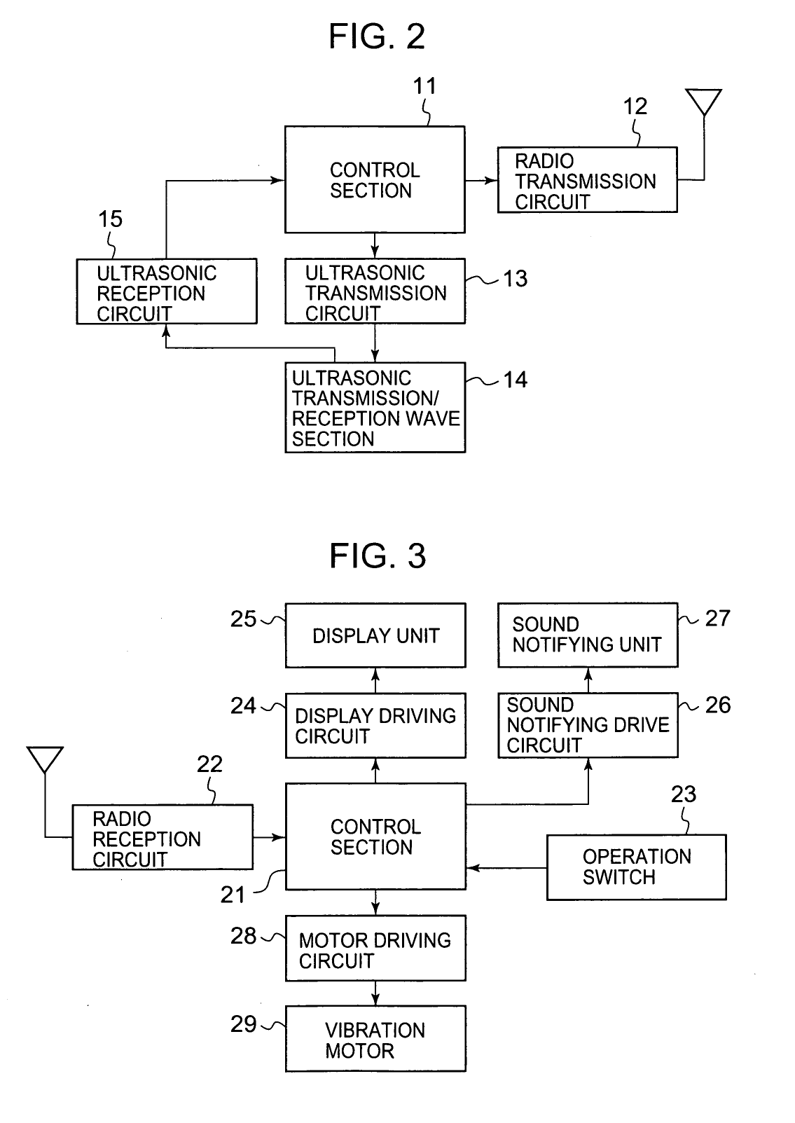

A fish detector for a fishing from rocks of the shore of an Embodiment 1 comprises the ultrasonic sensor unit 10 having a function of the float of the fishing tackle, and the arm-portable type data display unit 20 which receives a radio signal from the ultrasonic sensor unit 10 and displays the fish shoal and the like. The ultrasonic sensor unit 10 is a unit of such a constitution as shown in a block diagram of FIG. 2, and the arm-portable type data display unit 20 is a unit of such a constitution as shown in a block diagram of FIG. 3.

That is, as shown in the block diagram of FIG. 2, the ultrasonic sensor unit 10 possessing in combination also the function of the float of the fishing tackle is constituted by a control section 11, a radio transmission circuit 12, an ultrasonic transmission circuit 13 which drives an ultrasonic transmission/reception wave section 14 to thereby generate and transmit the ultrasonic wave toward the water bottom, an ultrasonic reception circuit 15 which receives the ultrasonic wave having been reflected by and having returned from the water bottom, the fish shoal and the like through the ultrasonic transmission/reception wave section 14, and a float type container accommodating these constituent elements. The control section 11 is one which calculates a distance information from a time at which the ultrasonic transmission circuit 13 has transmitted the ultrasonic wave and a time at which the ultrasonic reception circuit 15 has received the ultrasonic wave having been reflected by and having returned from the water bottom, the fish shoal and the like. The radio transmission circuit 12 is one which radio-transmits the distance information toward the arm-portable type data display unit 20.

As shown in the block diagram of FIG. 3, the arm-portable type data display unit 20 is constituted by a control section 21, a radio reception circuit 22, an operation switch 23, and notification sections of three kinds of an image type notification section, a sound type notification section, and a vibration type notification section. The image type notification section is constituted by a display driving circuit 24 and a display unit 25, the sound type notification section is constituted by a sound notifying drive circuit 26 and a sound notifying unit 27, and the vibration type notification section is constituted by a motor driving circuit 28 and a vibration motor 29.

The radio reception circuit 22 receives the distance information having been radio-transmitted from the ultrasonic sensor unit 10, and inputs it to the control section 21. The control section 21 signal-processes the inputted distance information, judges whether or not the fish shoal exists and, in a case where it has been judged that the fish shoal approaches, generates a fish shoal approach signal. Subsequently, the control section 21 drives the image type notification section, the sound type notification section and the vibration type notification section on the basis of the fish shoal approach signal, thereby notifying the fish shoal approach to the user. That is, the control section 21 controls the display driving circuit 24, thereby displaying the fish shoal approach to the display unit 25 by image or letter. Further, the control section 21 controls the sound notifying drive circuit 26 to operate the sound notifying unit 27, thereby notifying the fish shoal approach by sound. Additionally, the control section 21 controls the motor driving circuit 28 to operate the vibration motor 29, thereby notifying the fish shoal approach by vibration. Incidentally, the operation switch 23 is a switch inputting which of the image type notification section, the sound type notification section and the vibration type notification section should be used to the control section 21.

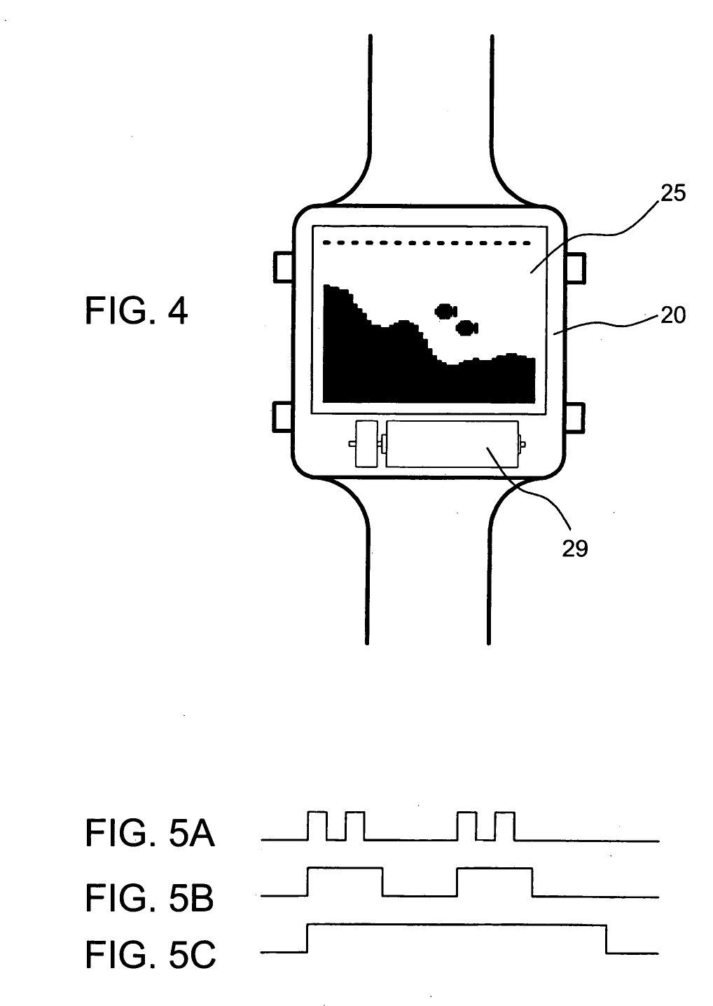

Since the portable type data display unit 20 is such a wrist watch type data display unit as shown in FIG. 4, the vibration notifying the fish shoal approach is surely transmitted to the user. Further, the vibration type notification section is constituted so as to vibrate by a pattern corresponding to a size of signs of fish. For example, as shown in vibration waveform patterns of FIG. 5, it is adapted such that, by a short time vibration (A) of two times in a case where the detected signs of fish are small, by a long time vibration (B) in a case where the signs of fish are middle and additionally by a longer time vibration (C) in a case where the signs of fish are large, it is notified to the user to that effect.

Since the present invention is one which, in the fish detector for the fishing from rocks near the shore which possesses the arm-portable type data display unit, possesses the vibration type notification unit which notifies by vibration the fish shoal approach to the arm-portable type data display unit, it has become possible that the user who is enjoying the fishing from rocks near the shore simply and surely know the fish shoal approach by the vibration given to his/her arm, and further a discrimination in size of the fish shoal by a vibration pattern has become possible as well. Moreover, in the present invention, since the vibration notifying the fish shoal approach is not transmitted to the fishing rod, there is completely no fear that the undesirable vibration is generated in the fishing rod. Further, by the present invention, it has become unnecessary to continue to see in concentration the display panel for a long time, so that a burden for the user has been reduced. Additionally, the problem in the notification of the fish shoal approach by the buzzer sound and the like, i.e., difficulty in hearing the sound due to the sounds of wave and wind and the like, could be solved by the present invention as well.

1. A fish detector comprising:
an ultrasonic sensor unit which is accommodated in a container, serving also as a float, used while being attached to a fishline and which transmits by radio a time information till an ultrasonic wave having been sent out toward a water bottom is reflected by the water bottom or a fish shoal and returns to it,
a control section to judge a water depth and the fish shoal on the basis of a data received from the ultrasonic sensor unit,
a vibration type notification section to notify an approach of the fish shoal to a user by vibration, and
a display section to display an information to a display screen.

2. A fish detector according to claim 1, wherein the vibration type notification section is one which gives the vibration to an arm of the user.

3. A fish detector according to claim 1, wherein the vibration type notification section is one which vibrates by a pattern corresponding to a size of signs of fish.

4. A fish detector according to claim 1, wherein the vibration type notification section is one which contains a vibration motor.

5. A fish detector according to claim 1, further comprising: a sound notifying unit to notify the approach of the fish shoal to the user by a sound notification.

6. A fish detector according to claim 5, wherein the control section selects either or both of the vibration type notification section and the sound notifying unit.
